(19) United States
(12) Patent Application Publication
(10) Pub. No.: US 2009/0230674 A1
(43) Pub. Date: Sep. 17, 2009

(54) Fuel Port Elbow Having a Truncated Conductive Insert Tube

(75) Inventors: William L. Villaire, Clarkston, MI (US); Robert Halsall, Washington, MI (US); Peter N.C. Nguyen, Sterling Heights, MI (US); Mitchell E. Hart, Grand Blanc, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 12/103,764

(22) Filed: Apr. 16, 2008

Related U.S. Application Data
(60) Provisional application No. 61/036,536, filed on Mar. 14, 2008.

(51) Int. Cl. F16L 43/00

(52) U.S. Cl. 285/179; 123/495

(57) ABSTRACT

A fuel port elbow composed of a plastic port body overmolding an electrically conductive, truncated insert tube such that there is no external dissimilar materials boundary. The tube has a tube first segment, a tube elbow segment and a tube second segment truncated such that the dissimilar materials boundary at the tube truncation is internal to the port body. A port body is integral with the plastic of a flange cover, and overmolds part of the tube first segment and all of the tube elbow and second segments. The port body has a port body second segment having a port body passage communicating with the tube passage and extending remotely from the tube truncation, being adapted for connecting with a fuel line.

### CROSS-REFERENCE TO RELATED APPLICATIONS

The present patent application claims the benefit of provisional patent application Ser. No. 61/036,536, filed on Mar. 14, 2008, which application is presently pending.

### TECHNICAL FIELD

The present invention relates to fuel pump modules which are interfaced with fuel tanks for motor vehicles, and more particularly to a fuel port of the cover flange thereof. Still more particularly, the present invention relates to a fuel port elbow having an overmolded, electrically conductive, truncated insert tube.

### BACKGROUND OF THE INVENTION

Motor vehicle fuel tanks provide not only a reservoir for fuel but also must have accommodation for adding fuel, delivering fuel (i.e., to the engine) and monitoring the amount of the fuel therein. It has become a common practice to combine the fuel delivery and monitoring functions via a fuel pump module which is removably interfaced with an opening of the fuel tank sidewall.

FIG. 1 depicts an example of a motor vehicle fuel tank 10 having, by way of example, a saddle shape featuring two fuel sumps 10a, 10b. The fuel tank sidewall 12 is provided with first and second openings 12a, 12b, each opening being disposed over a respective fuel sump 10a, 10b. At the first sump 10a, and interfaced sealingly with the first opening 12a, is a fuel pump module 14, and at the second sump 10b and interfaced sealingly with the second opening 12b is a secondary fuel transfer source 16 which is fluidically connected to the fuel pump module 14 via a transfer line 18.

The fuel pump module may be a part of a return fuel system or of a returnless fuel system. With respect to a return fuel system, now used mostly in diesel fuel applications, there are feed and return fuel lines, wherein fuel is constantly pumped, and what is not used by the engine is returned to the fuel tank. In a returnless fuel system, which is used most commonly today, fuel is supplied on demand to the engine, there being no return fuel line, only a feed fuel line connected with the fuel pump module. Returnless fuel systems may be of a mechanical type, commonly referred to as “MRFS” or of an electronic type, commonly referred to as “ERFS”, depending on the control modality of the fuel system.

FIG. 2 depicts a schematic representation of the functional aspects of a fuel pump module 20 utilized in the prior art, as for example in the manner of fuel pump module 14 in FIG. 1 with respect to a fuel tank of a returnless fuel system. A module reservoir 22 is defined by a plastic module sidewall 20a. A fuel pump 24 draws fuel through a fuel strainer 26 in the module reservoir. The pumped fuel F is then sent via a connector conduit 28 to a fuel filter 30, whereupon after filtering, the fuel passes through a filter conduit 32 to a fuel port elbow 34 from which the fuel is delivered to the engine via a feed fuel line 35. By way of comparison, in a return fuel system the fuel is continuously pumped, and any amount not utilized by the engine is returned to the fuel pump module 20 by a return fuel line (not shown), and for this purpose a second fuel port elbow would be provided which is connected with the fuel return line, the return fuel being dumped into the module reservoir. The fuel port elbow 34 (and, if present, also the second fuel port elbow) is sealingly connected with a cover flange 36 which is, in turn, sealingly seated at the first opening 12a and removably affixed thereto by a locking ring 40 (see FIG. 1). A fuel level sensor 42 is connected with the module sidewall 20a, which may be, for example, of the pivoting float type. A pressure relief valve 44 is located at the fuel filter 30. Guide rods 46, having guide springs, guidably interconnect the cover flange 36 with the module sidewall 20a.

In order to supply electricity to operate the fuel pump 24 and the fuel level sensor 42, electrical leads 38 are provided: power and ground leads 38a, 38b for the fuel pump and voltage in and out leads 38c, 38d for the fuel level sensor. In view of the electrical interconnections, it is desirable for the fuel pump 24, the connector conduit 28, the fuel filter 30 and the filter conduit 32 to be electrically conductive and be connected, along with the fuel level sensor 42, via for example a grounding lead 38e, to the ground lead 38b (in applications where the fuel pump is absent, grounding is via a ground lead with the fuel level sensor). The guide rods 46 are metallic and also connected to ground.

It is known that conduit surfaces which are exposed to turbulent fuel flow may, under some circumstances, acquire an electrostatic (or static electric) charge. It is further known that electrostatic charge can be removed by electrically connecting a charged object to an electrical ground. In this regard, SAE International report entitled “Surface Vehicle Recommended Practice” regarding “Fuel Systems and Components—Electrostatic Charge Mitigation”, report number SAE J1645 issued February 1994 and revised August 2006, which report is hereby herein incorporated by reference, sets forth a standard for the insulative portions of a fuel system which do not need to be conductive and grounded (see Section A.4 and subsections thereof), provided the fuel flow path is short or if multiple ground paths are provided, wherein “short” is considered to be (see subsection A.4.2) as less than about one-tenth of the product of the highest mean fuel flow velocity times the dielectric relaxation time of the fuel. Irrespective of the foregoing, in the portions of conduits where relatively low fuel flow rates are present, conductive and grounded portions may not be needed as a countermeasure for electrostatic charge accumulation.

Because fuel flowing through the fuel port elbow experiences a 90 degree change in direction, it is possible for fuel flow turbulence to develop thereat. Whether or not that can result in electrostatic charge accumulation, it is the practice in the art to have the fuel port elbow include a conductive material, such as an electrically conductive tube 48 as shown at FIG. 3A, which is electrically connected to the electrical ground lead, via, for example, the electrical connections as between the filter conduit 32, the fuel filter 30, the connector conduit 28 and the grounded fuel pump 24.

The prior art fuel port elbow 34 of FIG. 2 is shown in detail at FIG. 3A. The fuel port elbow 34 includes a conductive plastic (i.e., a plastic with for example graphite or metallic particle fill) tube 48, having a first tube component 48a, a second tube component 48b, and an elbow tube component 48c joining the first and second tube components at right angle to each other, wherein the first tube component has a nipple 48d for connecting to the filter conduit and the second tube component has a nipple 48e for connecting to the fuel line.

The tube 48 provides a suitable electrical conductivity, but the first tube component 48a is partly above and partly below the cover flange 36, wherein the conductive plastic thereof must be sealed in relation to the non-conductive plastic of the cover flange 36. The prior art sealing solution is to provide a plastic cap flange upper overmold 50 which is inclusive of the elbow tube component 48c, and a plastic cap flange lower overmold 52, wherein the cap flange upper overmold and the cap flange lower overmold are integral with the plastic of the cap flange 36, and each terminate at a respective upper and lower annulus 54, 56 of the tube 48.

Referring next to FIGS. 3B through 3D other prior art fuel port elbows known in the prior art will be briefly discussed.

At FIG. 3B, a prior art fuel port elbow 60 is depicted in which a metallic tube 62 has a first tube component 62a, a second tube component 62b, and an elbow tube component 62c joining the first and second tube components, with nipples 62d, 62e as generally recounted for the purposes with respect to FIG. 3A. A cap flange upper overmold 66a extends above the upper side 64a of the cap flange 64, and a cap flange lower overmold 66b extends below the cap flange underside 64b, both overmolds being integral with the plastic of the cap flange 64.

At FIG. 3C, a prior art fuel port elbow 70 is depicted in which a metallic tube 72 has a first tube component 72a, a second tube component 72b, and an elbow tube component 72c joining the first and second tube components, with similar attributes to the fuel port elbow 60 of FIG. 3B. Now, the cap flange 74 is metallic and sealingly conjoined by welding or brazing 76 between the tube 72 and a collar 78 of the cap flange 74.

At FIG. 3D, a prior art fuel port elbow 80 is depicted in which an electrically conductive plastic tube 82 has a first tube component 82a, a second tube component 82b, and an elbow tube component 82c joining the first and second tube components, wherein the first tube component has a nipple 82d for connecting to the fuel filter and the second tube component has a nipple 82e for connecting the fuel line. The cap flange 84 is also composed of the conductive plastic material and integral with the electrically conductive plastic tube. The electrically conductive plastic is, for example, plastic with a metal particle or graphite fill.

While the prior art fuel port elbow 34 works well for fuel feed in a returnless fuel system and for both fuel feed and fuel return in a return fuel system, an external boundary 58 exists at the upper annulus, where the dissimilar plastic materials conjoin with each other, whereat problems could arise related to exposure to the elements of weather external to the fuel tank or fuel vapor permeation to the atmosphere, which problems could be exacerbated by manufacturing tolerances. The other types of prior art fuel port elbows have drawbacks as well. For example, the partly overmolded metal tube fuel port elbow 60 has an exterior dissimilar materials boundary 68; the metal only fuel port elbow 70 requires the cap flange be made out of metal instead of plastic, which is more expensive; and, finally, the all plastic fuel port elbow 80 requires the cap flange and the fuel port elbow to be constructed of relatively expensive electrically conductive plastic.

Accordingly, it would be desirable if somehow the conductivity at the fuel port elbow could be provided, while at the same time eliminating all the drawbacks of the prior art.

### SUMMARY OF THE INVENTION

The present invention is a fuel port elbow composed of a plastic port body overmolding an electrically conductive, truncated insert tube such that there is no external dissimilar materials boundary.

The fuel port elbow according to the present invention includes an electrically conductive, truncated insert tube having a tube passage. The truncated insert tube includes an insert tube first segment which passes through a cover flange for the fuel tank; an insert tube second segment which is oriented generally perpendicular to the insert tube first segment; and an insert tube elbow segment which joins the insert tube first and second segments. The insert tube second segment is truncated.

The fuel port elbow according to the present invention further includes a plastic port body sealingly connected with the plastic of the cover flange, wherein the port body includes a port body first segment which is sealingly connected to the cover flange, preferably by being integrally formed therewith; a port body second segment which is generally perpendicular in relation to the port body first segment and carries a port body passage; and a port body elbow segment which joins the port body first and second segments.

Above the flange cover (i.e., exterior to the fuel pump module) the insert tube first segment, the insert tube elbow segment and the insert tube second segment are overmolded by the port body, whereby the tube passage aligns and communicates with the port body passage, and the dissimilar materials boundary as between the plastic of the port body and the electrically conductive material of the insert tube is internal to the port body. Below the flange cover (i.e., interior to a fuel pump module), the insert tube first segment is overmolded by a lower overmold to an annulus of the insert tube first segment.

The length of the insert tube second segment, that is, the location of the tube truncation, is predetermined by the location at which fuel flow has exited the highly turbulent turn of the insert tube elbow segment and has now become less turbulent. More particularly, per SAE J1645, Section A.4 thereof, the truncation is disposed such that the adjoining port body passage immediately downstream of the truncation is short (as defined in SAE J1645), straight and has two adjacent internal ground paths (one ground path being the insert tube at one end of the port body passage and a conductive fuel line at the other end of the port body passage), such that the port body second segment (which provides the port body passage) may be insulative.

Advantageously, the fuel port elbow according to the present invention provides an electrically conductive surface at the interior of the elbow portion thereof where turbulent fuel flow may arise, minimizes insert tube material cost, and eliminates an external dissimilar materials boundary.

Accordingly, it is an object of the present invention to provide a fuel port elbow composed of a plastic port body overmolding an electrically conductive insert tube such that there is no external dissimilar materials boundary.

This and additional objects, features and advantages of the present invention will become clearer from the following specification of a preferred embodiment.

### BRIEF DESCRIPTION OF THE DRAWINGS

FIG. 1 is a perspective view of a fuel tank, showing in particular a fuel pump module interfaced therewith.

FIG. 2 is a schematic representation of a prior art fuel pump module for a fuel tank, wherein the fuel port elbow thereof is known in the prior art.

FIG. 3A is a broken-away, sectional side view of a cover flange for a fuel pump module, wherein, per the prior art, the fuel port elbow thereof is characterized by a conductive plastic insert tube being partially overmolded, as depicted at FIG. 2.

FIG. 3B is a broken-away sectional side view of a cover flange for a fuel pump module, wherein, per the prior art, the fuel port elbow thereof is characterized by a metallic insert tube being partly overmolded.

FIG. 3C is a broken-away sectional side view of a cover flange for a fuel pump module, wherein, per the prior art, the fuel port elbow thereof and the cover flange are both metallic.

FIG. 3D is a broken-away sectional side view of a cover flange for a fuel pump module, wherein, per the prior art, the fuel port elbow thereof and the cover flange are both composed of an electrically conductive plastic.

FIG. 4 is a schematic representation of a fuel pump module for a fuel tank for a returnless fuel system, wherein the fuel port elbow thereof is according to the present invention.

FIG. 5 is a broken-away, sectional side view of a cover flange for a fuel pump module, wherein, according to the present invention, the fuel port elbow thereof is characterized by an overmolded electrically conductive insert tube that is truncated such that the dissimilar materials boundary is internalized to the overmold, as depicted at FIG. 4.

FIG. 6 is a partly sectional, perspective view of a fuel pump module including a pair of fuel port elbows according to the present invention for use in a return fuel system.

### DESCRIPTION OF THE PREFERRED EMBODIMENT

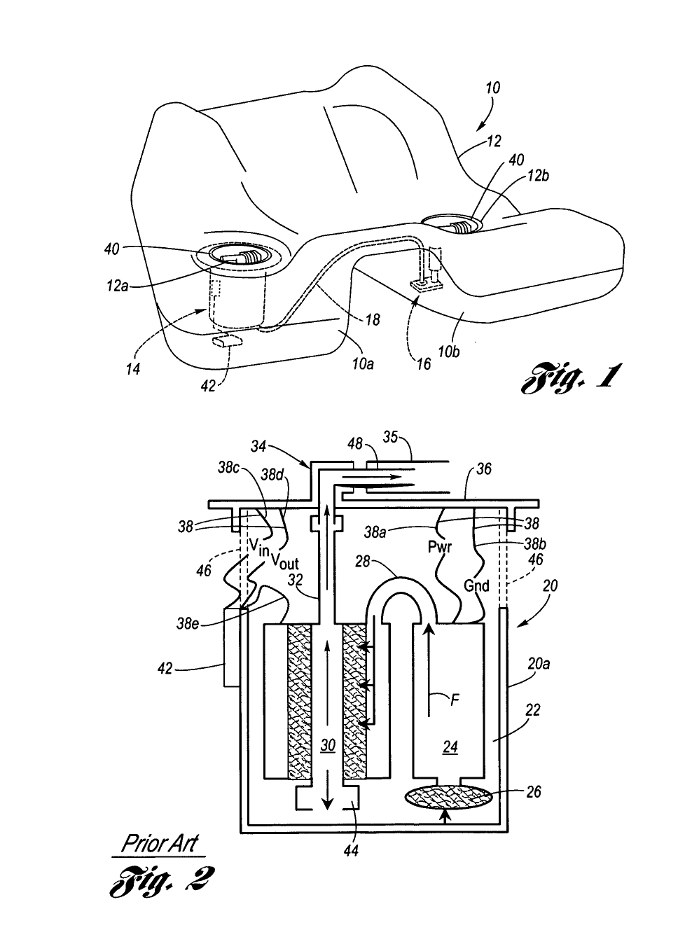

Referring now to the Drawing, FIGS. 4 through 6 depict various aspects of a fuel port elbow 100 which is sealingly connected to a cover flange of a fuel pump module of a fuel tank (as for example see 10 at FIG. 1).

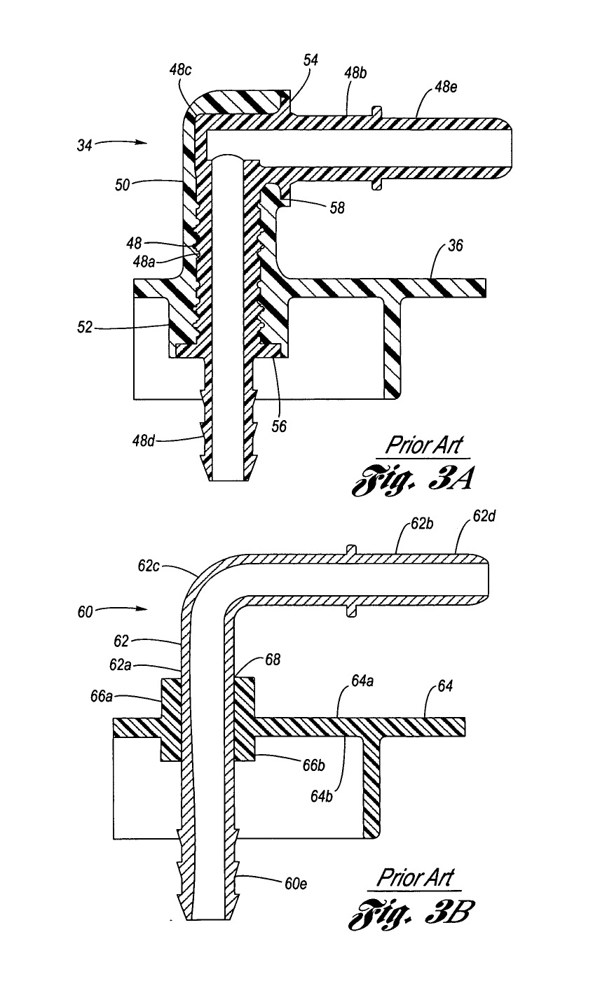

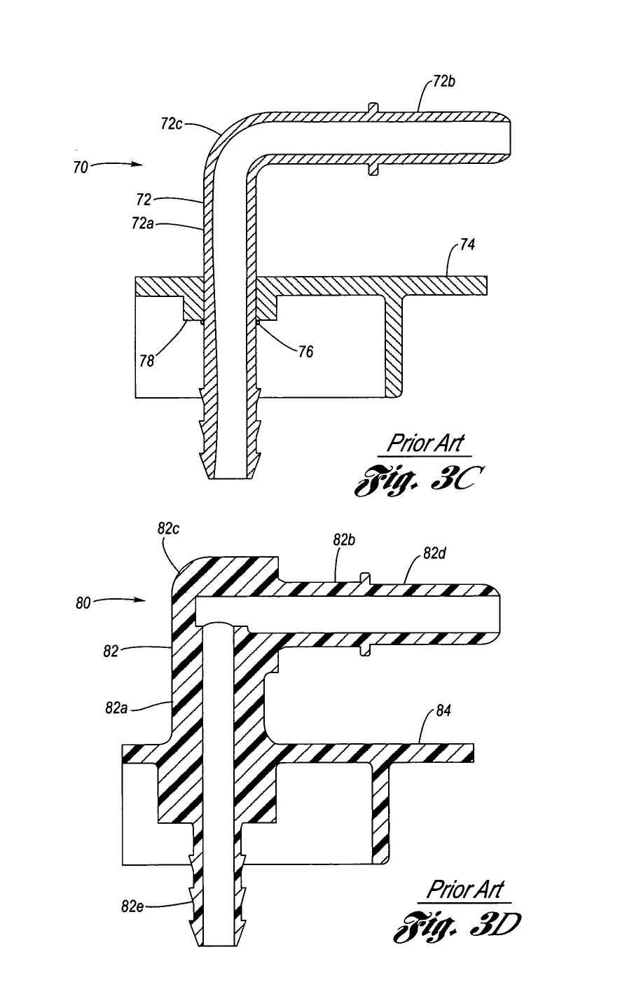

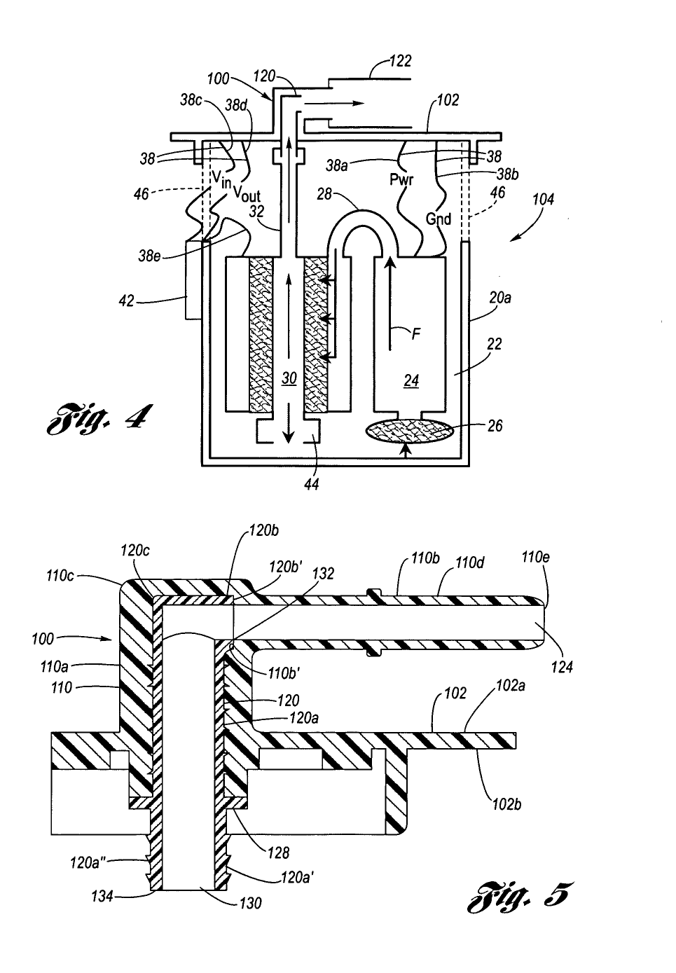

FIG. 4 depicts a schematic representation of the functional aspects of a fuel pump module 104 similar to that discussed above at FIG. 2 with respect to a fuel tank of a returnless fuel system, wherein the primary difference of FIG. 4 with respect to FIG. 2 is the fuel port elbow 100 according to the present invention, and wherein the description shall utilize similar numerals to describe similar components.

A module reservoir 22 is defined by a plastic module sidewall 20a. A fuel pump 24 draws fuel through a fuel strainer 26 in the module reservoir. The pumped fuel F is then sent via a connector conduit 28 to a fuel filter 30, whereupon after filtering, the fuel passes through a filter conduit 32 to a fuel port elbow 34 from which the fuel is delivered to the engine via a feed fuel line 122, which is electrically conductive and grounded. By way of comparison, in a return fuel system the fuel is continuously pumped, and any amount not utilized by the engine is returned to the fuel pump module 20 by a return fuel line (see FIG. 6), and for this purpose a second fuel port elbow would be provided which is connected with the fuel return line, the return fuel being dumped into the module reservoir. The fuel port elbow 34 (and, if present, also the second fuel port elbow) is sealingly connected with a cover flange 102 which is, in turn, sealingly seated at the first opening 12a and removably affixed thereto by a locking ring 40 (see FIG. 1). A fuel level sensor 42 is connected with the module sidewall 20a, which may be, for example, of the pivoting float type. A pressure relief valve 44 is located at the fuel filter 30. Guide rods 46, having guide springs, guidably interconnect the cover flange 36 with the module sidewall 20a.

In order to supply electricity to operate the fuel pump 24 and the fuel level sensor 42, electrical leads 38 are provided: power and ground leads 38a, 38b for the fuel pump and voltage in and out leads 38c, 38d for the fuel level sensor. In view of the electrical interconnections, the fuel pump 24, the connector conduit 28, the fuel filter 30 and the filter conduit 32 are electrically conductive and connected, along with the fuel level sensor 42, via for example a grounding lead 38e, to the ground lead 38b (in applications where the fuel pump is absent, grounding is via a ground lead with the fuel level sensor). The guide rods 46 are metallic and also connected to ground.

The fuel port elbow 100 includes an electrically conductive insert tube 120 which is electrically connected to the electrical ground lead, via, for example, the electrical connections as between the filter conduit 32, the fuel filter 30 the connector conduit 28 and the grounded fuel pump 24.

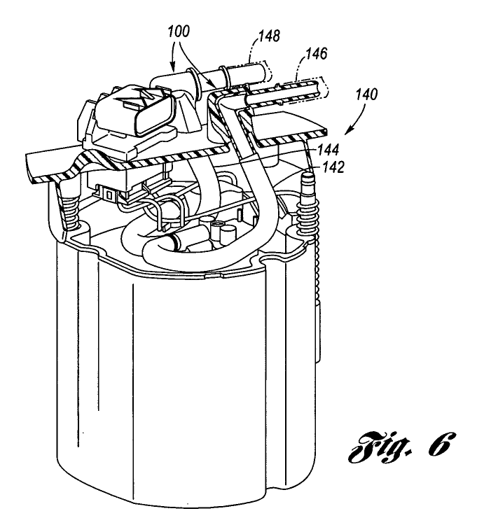

As shown at FIG. 5, the fuel port elbow 100 according to the present invention includes a plastic port body 110 sealingly connected with the upper side 102a (i.e., exterior to the fuel pump module) of the cover flange 102. The port body 110 includes a port body first segment 110a which is sealingly connected to, preferably by being integrally formed with, the plastic of the cover flange 102. The port body 110 also includes a port body second segment 110b which is generally perpendicular to the port body first segment, has a port body passage 124, and is adapted for connecting to the electrically conductive fuel line (see 122 of FIG. 4), as for example via a nipple 110d. The port body 110 further includes a port body elbow segment 110c, wherein the port body elbow segment joins the port body first and second segments 110a, 110b.

As additionally shown at FIG. 5, the fuel port elbow 100 further includes an electrically conductive, truncated insert tube 120, defining a tube passage 130. The truncated insert tube 120 is preferably composed of a conductive plastic, as for example a plastic with a conductive material fill, as for example metal particles or graphite, or composed of another conductive material. The truncated insert tube 120 includes an insert tube first segment 120a which passes through the cover flange 102; an insert tube second segment 120b which is oriented generally perpendicular to the insert tube first segment; and an insert tube elbow segment 120c joining the insert tube first and second segments. The insert tube second segment 120b is truncated 120b′, the location being for example generally adjacent the insert tube elbow segment 120c. The portion 120a′ of the insert tube first segment 120a which is intended to be located within the fuel pump module carries an annulus 128, and between the annulus and a terminal end 134 is adapted to connect to the electrically conductive filter conduit (see 32 of FIG. 4), as for example via a nipple 120a″.

The length of the insert tube second segment 120b, that is, the location of the tube truncation 120b′, is predetermined by the location at which fuel flow has exited the highly turbulent turn of the insert tube elbow segment 120c and has now become less turbulent. More particularly, per SAE J1645, Section A.4 thereof, the truncation is disposed such that the adjoining port body passage 124 immediately downstream of the truncation is short (as defined in SAE J1645), straight and has two adjacent internal ground paths, wherein one ground path is the insert tube 120 at the end of the port body passage (where the truncation is disposed and whereat a dissimilar materials boundary 132 exists), and the other ground path is the conductive fuel line 122 (see FIG. 4) disposed at the other end of the port body passage (i.e., where the distal end 110e of the insert tube second segment is located), such that the port body second segment (which provides the port body passage) may be insulative.

According to a methodology of making, the truncated insert tube is placed into a plastic injection tool, and plastic is injected to form the cap flange and the port body, and, at the underside 102b of the flange cover (i.e., interior to the fuel pump module), the insert tube first segment 120a is overmolded by a lower overmold 126 to the annulus 128 of the insert tube first segment. At the upperside 102a of the flange cover (i.e., exterior to the fuel pump module), the insert tube first segment, the insert tube elbow segment 120c, and the insert tube second segment 120c are overmolded by the port body, whereby the truncation 120b′ of the insert tube second segment 120b flushly abuts 110b′ the port body second segment 110b such that the tube passage 130 is smoothly aligned and communicates with the port body passage 124. The port body second segment 110b overmolding of the insert tube second segment 120b is such that a distal end 110e of the port body second segment is disposed in spaced relation with respect to said tube second segment, whereby the dissimilar materials boundary 132 as between the plastic of the port body and the conductive plastic of the truncated insert tube is internal to the port body.

Turning attention now to FIG. 6, a fuel pump module 140 for a return fuel system is depicted. A feed fuel conduit 142 and a return fuel conduit 144 are each equipped with a respective fuel port elbow 100 according to the present invention, which is, in turn, respectively connected to a feed fuel line 146 and a return fuel line 148.

To those skilled in the art to which this invention appertains, the above described preferred embodiment may be subject to change or modification. Such change or modification can be carried out without departing from the scope of the invention, which is intended to be limited only by the scope of the appended claims.

1. A fuel port elbow, comprising:
an electrically conductive tube having a tube passage therethrough, said tube comprising:
a tube first segment;
a tube second segment; and
a tube elbow segment joining with said tube first and second segments;
wherein said tube second segment is truncated at a tube truncation; and
a plastic port body comprising:
a port body first segment overmolding a selected portion of said tube first segment;
a port body elbow segment overmolding said tube elbow segment; and
a port body second segment overmolding said tube second segment and having a distal end disposed in spaced relation with respect to the truncation of said tube second segment, wherein said port body first and second segments are joined by said port body elbow segment, and wherein a port body passage is formed in said port body second segment;
wherein said port body passage and said tube passage are aligned and mutually communicating; and
wherein the tube truncation is located such that a dissimilar materials boundary of said tube and said port body is internal to said port body.

2. The fuel port elbow of claim 1, wherein the tube truncation is disposed at a predetermined location whereat fuel turbulence in said port body passage downstream of the tube truncation has decreased with respect to turbulence at said tube elbow segment, and wherein said port body passage comprises a short, straight passage having at least two electrical grounds connected thereto.

3. The fuel port elbow of claim 2, wherein said tube elbow segment and said port body elbow mutually provide a substantially perpendicular relationship of said tube first segment and said port body first segment with respect to said tube second segment and said port body second segment.

4. The fuel port elbow of claim 3, wherein between the truncation of said tube second segment and said distal end of said port body second segment, said port body second segment is adapted to connectingly interface with an electrically conductive and grounded fuel line.

5. The fuel port elbow of claim 4, wherein said tube comprises an electrically conductive plastic material.

6. The fuel port elbow of claim 4, wherein said tube second segment is truncated substantially adjacent said tube elbow segment.

7. A fuel port elbow and cap flange comprising:
a plastic cap flange having an upper side and an oppositely disposed underside;
an electrically conductive tube having a tube passage therethrough, said tube comprising:
a tube first segment passing through said cap flange;
a tube second segment; and
a tube elbow segment joining with said tube first and second segments;
wherein said tube second segment is truncated at a tube truncation; and
a plastic port body connected with said upper side of said cap flange, said plastic port body comprising:
a port body first segment overmolding a selected portion of said tube first segment;
a port body elbow segment overmolding said tube elbow segment; and
a port body second segment overmolding said tube second segment and having a distal end disposed in spaced relation with respect to the truncation of said tube second segment, wherein said port body first and second segments are joined by said port body elbow segment, and wherein a port body passage is formed in said port body second segment;
wherein said port body passage and said tube passage are aligned and mutually communicating; and
wherein the tube truncation is located such that a dissimilar materials boundary of said tube and said port body is internal to said port body.

8. The fuel port elbow and cap flange of claim 7, wherein the tube truncation is disposed at a predetermined location whereat fuel turbulence in said port body passage downstream of the tube truncation has decreased with respect to turbulence at said tube elbow segment, and wherein said port body passage comprises a short, straight passage having at least two electrical grounds connected thereto.

9. The fuel port elbow and cap flange of claim 8, wherein said port body is integrally formed with said cap flange; and further comprising:
an annulus connected with said tube first segment disposed in spaced relation with respect to said underside of said cap flange and spaced from a terminal end of said tube first segment; and
a lower overmolding of said tube first segment between said underside and said annulus, said lower overmolding being integrally formed with said cap flange.

10. The fuel port elbow and cap flange of claim 9, wherein said tube elbow segment and said port body elbow mutually provide a substantially perpendicular relationship of said tube first segment and said port body first segment with respect to said tube second segment and said port body second segment.

11. The fuel port elbow and cap flange of claim 10, wherein between said tube second segment and said distal end of said port body second segment, said port body second segment is adapted to connectingly interface with an electrically conductive and grounded fuel line.

12. The fuel port elbow and cap flange of claim 11, wherein said tube comprises an electrically conductive plastic material.

13. The fuel port elbow and cap flange of claim 11, wherein said tube second segment is truncated substantially adjacent said tube elbow segment.

14. A fuel pump module, comprising:
an electrically conductive conduit connected to an electrical ground;
a plastic cap flange having an upper side and an oppositely disposed underside;
an electrically conductive tube having a tube passage therethrough, said tube comprising:
a tube first segment passing through said cap flange;
a tube second segment; and
a tube elbow segment joining with said tube first and second segments;
wherein said tube second segment is truncated at a tube truncation; and
a plastic port body connected with said upper side of said cap flange, said plastic port body comprising:
a port body first segment overmolding a selected portion of said tube first segment;
a port body elbow segment overmolding said tube elbow segment; and
a port body second segment overmolding said tube second segment and having a distal end disposed in spaced relation with respect to the truncation of said tube second segment, wherein said port body first and second segments are joined by said port body elbow segment, and wherein a port body passage is formed in said port body second segment;
wherein said port body passage and said tube passage are aligned and mutually communicating;
wherein at said underside of said cap flange, said tube first segment is connected to said conduit such that said tube is connected to the electrical ground; and
wherein the tube truncation is located such that a dissimilar materials boundary of said tube and said port body is internal to said port body.

15. The fuel pump module of claim 14, wherein the tube truncation is disposed at a predetermined location whereat fuel turbulence in said port body passage downstream of the tube truncation has decreased with respect to turbulence at said tube elbow segment, and wherein said port body passage comprises a short, straight passage having at least two electrical grounds connected thereto.

16. The fuel pump module of claim 15, wherein said port body is integrally formed with said cap flange; and further comprising:
an annulus connected with said tube first segment disposed in spaced relation with respect to said underside of said cap flange and spaced from a terminal end of said tube first segment; and
a lower overmolding of said tube first segment between said underside and said annulus, said lower overmolding being integrally formed with said cap flange;
wherein the connection of said tube first segment to said conduit is between said annulus and said terminal end of said tube first segment.

17. The fuel pump module of claim 16, wherein said tube elbow segment and said port body elbow mutually provide a substantially perpendicular relationship of said tube first segment and said port body first segment with respect to said tube second segment and said port body second segment.

18. The fuel pump module of claim 17, wherein between said tube second segment and said distal end of said port body second segment, said port body second segment is adapted to connectingly interface with an electrically conductive and grounded fuel line.

19. The fuel pump module of claim 18, wherein said tube comprises an electrically conductive plastic material.

20. The fuel pump module of claim 18, wherein said tube second segment is truncated substantially adjacent said tube elbow segment.
